(19) United States
(12) Patent Application Publication
(10) Pub. No.: US 2013/0002053 A1
(43) Pub. Date: Jan. 3, 2013

(54) SLOTLESS MOTORS WITH GROOVED CORE

(76) Inventor: Alexei Stadnik, Beverly Hills, CA (US)

(21) Appl. No.: 13/335,159

(22) Filed: Dec. 22, 2011

Related U.S. Application Data
(60) Provisional application No. 61/460,268, filed on Dec. 28, 2010.

(51) Int. Cl. H02K 1/12; H02K 41/03

(52) U.S. Cl. 310/12.26; 310/216.002

(57) ABSTRACT

The invention provides slotless electrical motors with grooved core (grooved motors). The motors with grooved core are much easier in production than conventional motors with laminated core. Also, they do not have significant Eddy currents losses due to grooves.

I, Alexei Stadnik, claim priority of provisional application No. 61/460,268

### BACKGROUND OF THE INVENTION

The design of slotless motor includes coils mounted on the core. The easiest way for producing the core for coils mounting is using the solid metal ring or plate. However, the Eddy currents losses are very high for such motor (Eddy-Current Losses in Laminated and Solid Steel Stator Back Iron in a Small Rotary Brushless Permanent-Magnet Actuator by Johannes J. H. Paulides, Koen J. Meessen, and Elena A. Lomonova—IEEE TRANSACTIONS ON MAGNETICS, VOL. 44, NO. 11 NOVEMBER 2008). To reduce Eddy currents losses in motors, the laminated core for coils mounting is used (Unique Surface-Wound Brushless Servo with Improved Torque Ripple Characteristics by Thomas R. England—IEEE TRANSACTIONS ON INDUSTRY APPLICATIONS, VOL. 24. NO. 6. NOVEMBER/DECEMBER 1988). The process of producing the stack of laminations requires labor and a lot of tooling.

The motors with grooved core are much easier in production than conventional motors with laminated core. Also, they do not have significant Eddy currents losses due to grooves.

### DESCRIPTION OF THE FIGURES

FIG. 1.1—Rotary radial (internal rotor) slotless motor with stator that includes coils and solid or laminated core.

FIG. 1.2—Invented rotary radial (internal rotor) slotless motor with stator that includes coils and grooved core.

FIG. 2—Grooved core for invented rotary radial (internal rotor) slotless motor.

FIG. 3.1—Rotary radial (external rotor) slotless motor with stator that includes coils and solid or laminated core.

FIG. 3.2—Invented rotary radial (external rotor) slotless motor with stator that includes coils and grooved core.

FIG. 4—Grooved core for invented rotary radial (external rotor) slotless motor.

FIG. 5.1—Rotary axial slotless motor with stator that includes coils and solid or laminated core.

FIG. 5.2—Invented rotary axial slotless motor with stator that includes coils and grooved core.

FIG. 6—Grooved core for invented rotary axial slotless motor.

FIG. 7.1—Linear flat slotless motor with forcer that includes coils and solid or laminated core.

FIG. 7.2—Invented linear flat slotless motor with forcer that includes coils and grooved core.

FIG. 8—Grooved core for invented linear flat slotless motor.

FIG. 9.1—Linear tube (internal magnets) slotless motor with forcer that includes coils and solid or laminated core.

FIG. 9.2—Invented linear tube (internal magnets) slotless motor with forcer that includes coils and grooved core.

FIG. 10—Grooved core for invented tube (internal magnets) slotless motor.

FIG. 11.1—Linear tube (external magnets) slotless motor with forcer that includes coils and solid or laminated core.

FIG. 11.2—Invented linear tube (external magnets) slotless motor with forcer that includes coils and grooved core.

FIG. 12—Grooved core for invented tube (external magnets) slotless motor.

### DRAWINGS

### Reference Numerals

10—Stator that includes coils and solid or laminated core, rotary radial (internal rotor) slotless motor.
12—Coils, rotary radial slotless motor.
14—Epoxy
16—Solid or laminated core, rotary radial (internal rotor) slotless motor.
18—Rotor, rotary radial (internal rotor) slotless motor.
20—Bushing, rotary radial (internal rotor) slotless motor.
22—Magnets, rotary radial (internal rotor) slotless motor.
24—Stator that includes coils and grooved core, rotary radial (internal rotor) slotless motor.
26—Grooved core, rotary radial (internal rotor) slotless motor.
28—Grooves, rotary radial (internal rotor) slotless motor.
30—Stator that includes coils and solid or laminated core, rotary radial (external rotor) slotless motor.
32—Solid or laminated core, rotary radial (external rotor) slotless motor.
34—Rotor, rotary radial (external rotor) slotless motor.
36—Bushing, rotary radial (external rotor) slotless motor.
38—Magnets, rotary radial (external rotor) slotless motor.
40—Stator that includes coils and grooved core, rotary radial (external rotor) slotless motor.
42—Grooved core, rotary radial (external rotor) slotless motor.
44—Grooves, rotary radial (external rotor) slotless motor.
46—Stator that includes coils and solid or laminated core, rotary axial slotless motor.
48—Coils, rotary axial slotless motor.
50—Solid or laminated core, rotary axial slotless motor.
52—Rotor, rotary axial slotless motor.
54—Bushing, rotary axial slotless motor.
56—Magnets, rotary axial slotless motor.
58—Stator that includes coils and grooved core, rotary axial slotless motor.
60—Grooved core, rotary axial slotless motor.
62—Grooves, rotary axial slotless motor.
64—Forcer that includes coils and solid or laminated core, linear flat slotless motor.
66—Coils, linear flat slotless motor.
68—Solid or laminated core, linear flat slotless motor.
70—Magnet track, linear flat slotless motor.
72—Magnetic plate, linear flat slotless motor.
74—Magnets, linear flat slotless motor.
76—Forcer that includes coils and grooved core, linear flat slotless motor.
78—Grooved core, linear flat slotless motor.
80—Grooves, linear flat slotless motor.
82—Forcer that includes coils and solid or laminated core, linear tube (internal magnets) slotless motor.
84—Coils, linear tube slotless motor.
86—Solid or laminated core, linear tube (internal magnets) slotless motor.
88—Magnet track, linear tube (internal magnets) slotless motor.
90—Magnetic tube, linear tube (internal magnets) slotless motor.
92—Magnets, linear tube (internal magnets) slotless motor.
94—Forcer that includes coils and grooved core, linear tube (internal magnets) slotless motor.
96—Grooved core, linear tube (internal magnets) slotless motor.
98—Grooves, linear tube (internal magnets) slotless motor.
100—Forcer that includes coils and solid or laminated core, linear tube (external magnets) slotless motor.
102—Solid or laminated core, linear tube (external magnets) slotless motor.
104—Bushing, linear tube (external magnets) slotless motor.
106—Magnet track, linear tube (external magnets) slotless motor.
108—Magnetic tube, linear tube (external magnets) slotless motor.
110—Magnets, linear tube (external magnets) slotless motor.
112—Forcer that includes coils and grooved core, linear tube (external magnets) slotless motor.
114—Grooved core, linear tube (external magnets) slotless motor.
116—Grooves, linear tube (external magnets) slotless motor.

### DESCRIPTION OF THE PREFERRED EMBODIMENT

Rotary Radial (Internal Rotor) Slotless Motor with Grooved Core.

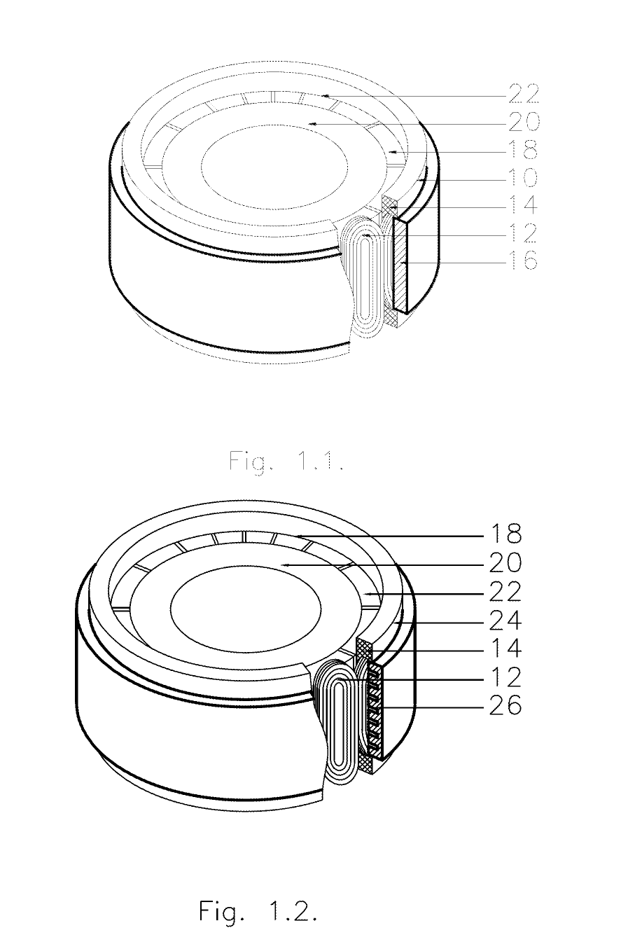

Rotary radial (internal rotor) slotless motor with stator that includes coils and solid or laminated core for coils mounting is shown on FIG. 1.1. Stator 10 consists of coils 12 encapsulated in epoxy 14 and solid or laminated core 16. Rotor 18 consists of bushing 20 and magnets 22.

The invented rotary radial (internal rotor) slotless motor construction includes stator 24 consisted of coils 12 encapsulated in epoxy 14, and grooved core 26 (FIG. 1.2). The grooved core replaces conventional solid or laminated core 16. It is much easier in production than laminated core and do not have significant Eddy currents losses due to grooves.

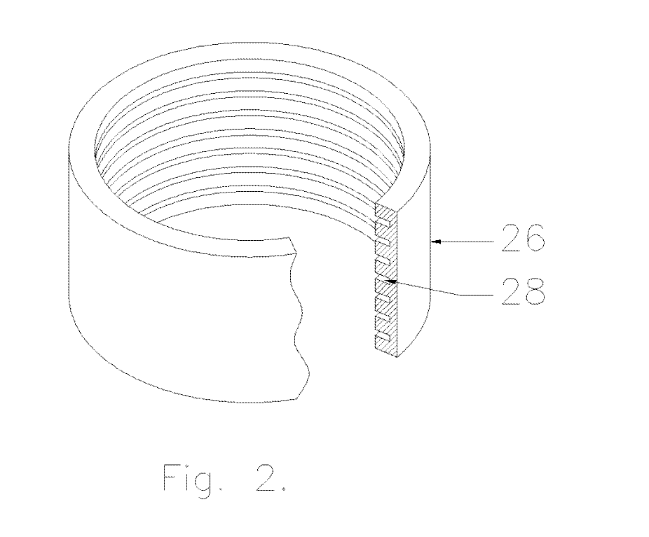

The grooved core 26 for rotary radial (internal rotor) slotless motor is shown on FIG. 2. It is made of solid oriented or non-oriented, ferromagnetic or non-ferromagnetic material or compound. Grooves 28 are made perpendicular the rotation axis (parallel to motor rotation), corkscrew direction, spiral direction or other direction. The exact dimensions, direction and quantity of grooves depend on electromechanical design and are subject for optimization.

Rotary Radial (External Rotor) Slotless Motor with Grooved Core.

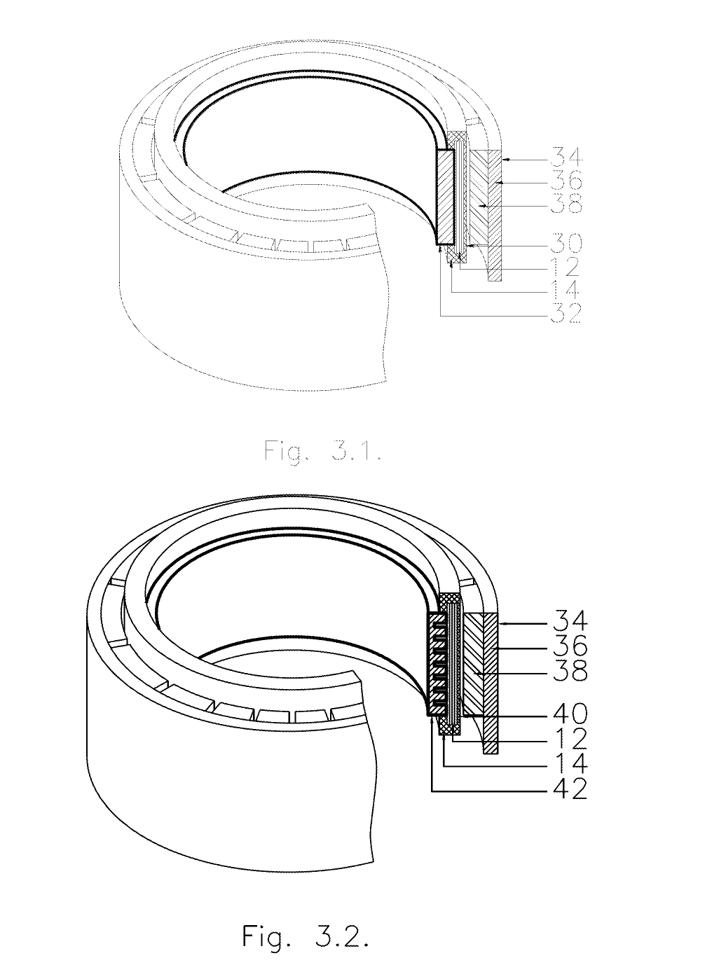

Rotary radial (external rotor) slotless motor with stator that includes coils and solid or laminated core for coils mounting is shown on FIG. 3.1. Stator 30 consists of coils 12 encapsulated in epoxy 14 and solid or laminated core 32. Rotor 34 consists of bushing 36 and magnets 38.

The invented rotary radial (external rotor) slotless motor construction includes stator 40 consisted of coils 12 encapsulated in epoxy 14, and grooved core 42 (FIG. 3.2). The grooved core replaces conventional solid or laminated core 32. It is much easier in production than laminated core and do not have significant Eddy currents losses due to grooves.

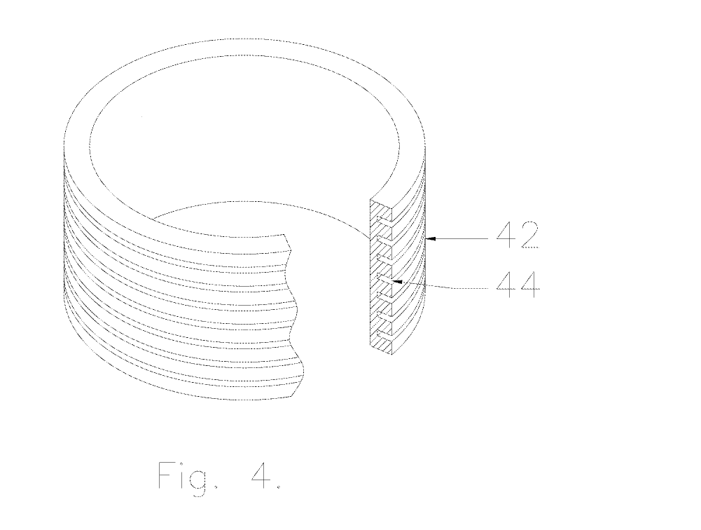

The grooved core 42 for rotary radial (external rotor) slotless motor is shown on FIG. 4. It is made of solid oriented or non-oriented, ferromagnetic or non-ferromagnetic material or compound. Grooves 44 are made perpendicular the rotation axis (parallel to motor rotation), corkscrew direction, spiral direction, or other direction. The exact dimensions, direction and quantity of grooves depend on electromechanical design and are subject for optimization.

Rotary Axial Slotless Motor with Grooved Core.

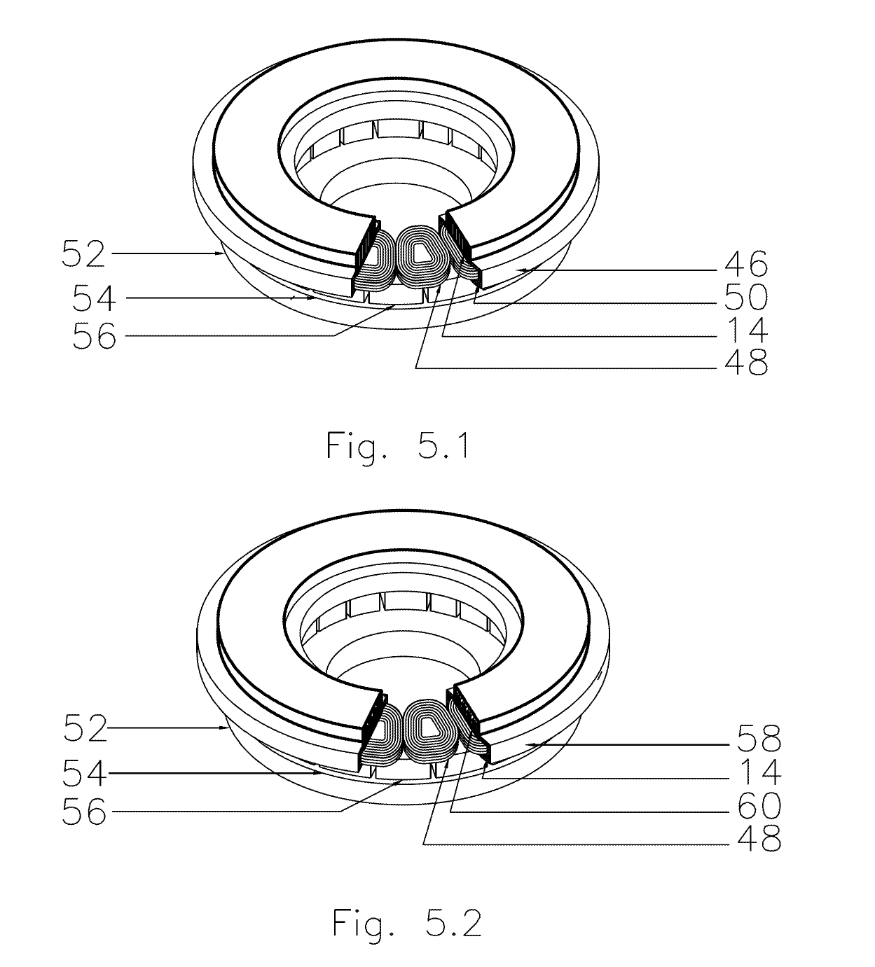

Rotary axial slotless motor with stator that includes coils and solid or laminated core for coils mounting is shown on FIG. 5.1. Stator 46 consists of coils 48 encapsulated in epoxy 14 and solid or laminated core 50. Rotor 52 consists of magnetic plate 54 and magnets 56.

The invented rotary axial slotless motor construction includes stator 58 consisted of coils 48 encapsulated in epoxy 14, and grooved core 60 (FIG. 5.2). The grooved core replaces conventional solid or laminated core 50. It is much easier in production than laminated core and do not have significant Eddy currents losses due to grooves.

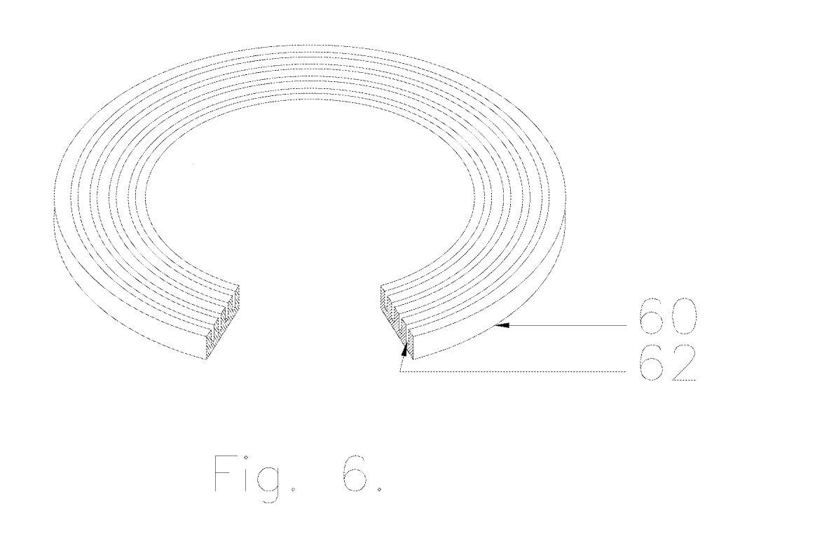

The grooved core 60 for rotary axial slotless motor is shown on FIG. 6. It is made of solid oriented or non-oriented, ferromagnetic or non-ferromagnetic material or compound. Grooves 62 are made perpendicular the rotation axis (parallel to motor rotation), corkscrew direction, spiral direction or other direction. The exact dimensions, direction and quantity of grooves depend on electromechanical design and are subject for optimization.

Linear Flat Slotless Motor with Grooved Core.

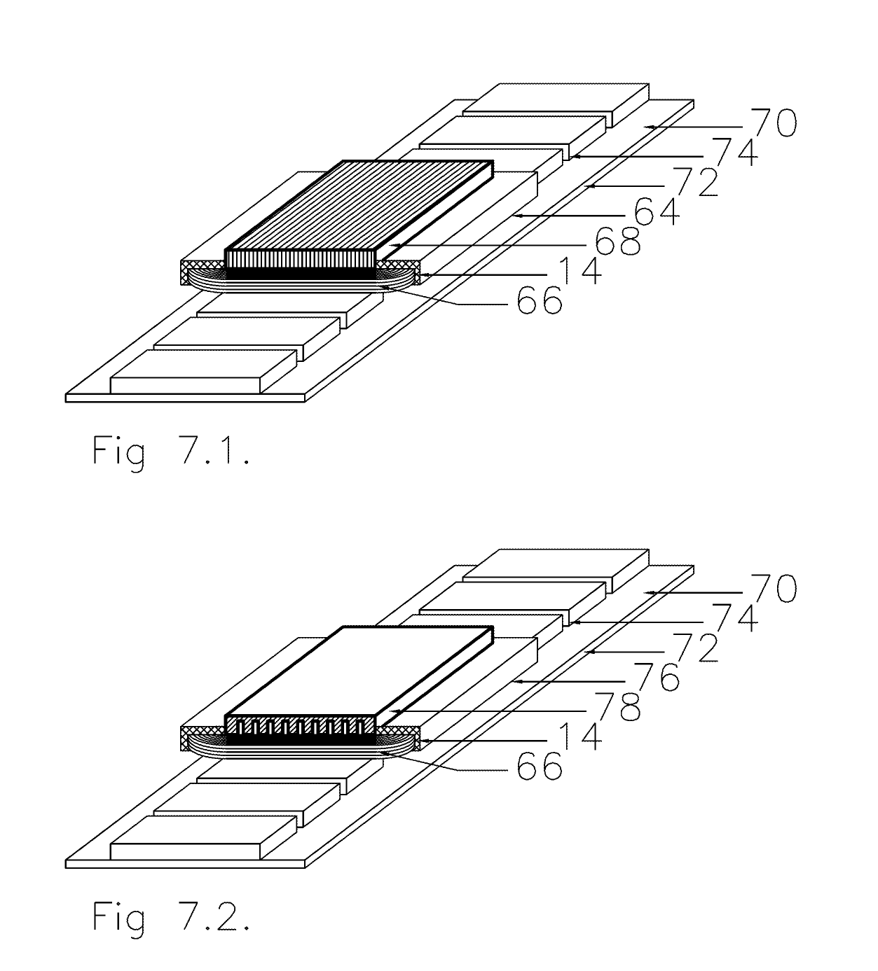

Linear flat slotless motor with forcer that includes coils and solid or laminated core for coils mounting is shown on FIG. 7.1. Forcer 64 consists of coils 66 encapsulated in epoxy 14 and solid or laminated core 68. Magnet track 70 consists of magnetic plate 72 and magnets 74.

The invented linear flat slotless motor construction includes forcer 76 consisted of coils 66 encapsulated in epoxy 14, and grooved core 78 (FIG. 7.2). The grooved core replaces conventional solid or laminated core 68. It is much easier in production than laminated core and do not have significant Eddy currents losses due to grooves.

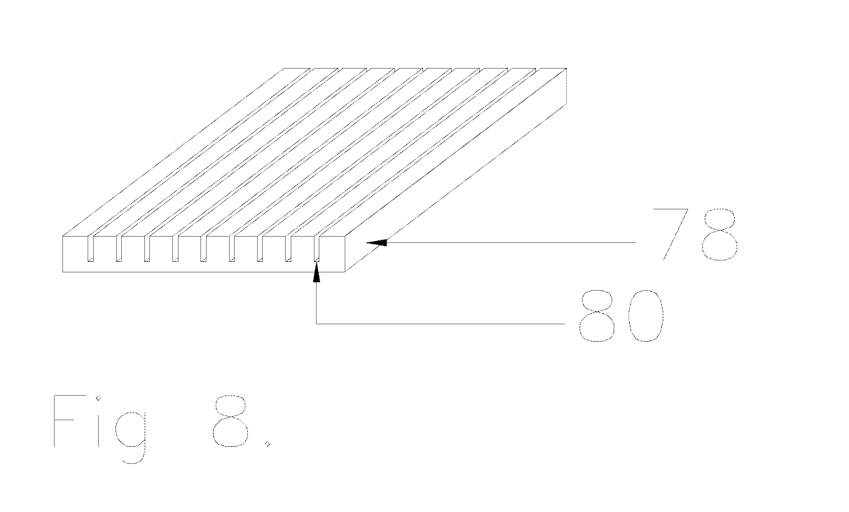

The grooved core 78 for linear flat slotless motor is shown on FIG. 8. It is made of solid oriented or non-oriented, ferromagnetic or non-ferromagnetic material or compound. Grooves 80 are made along the core length (parallel to motor moving direction) or other direction. The exact dimensions, direction and quantity of grooves depend on electromechanical design and are subject for optimization.

Linear Tube (Internal Magnets) Slotless Motor with Grooved Core.

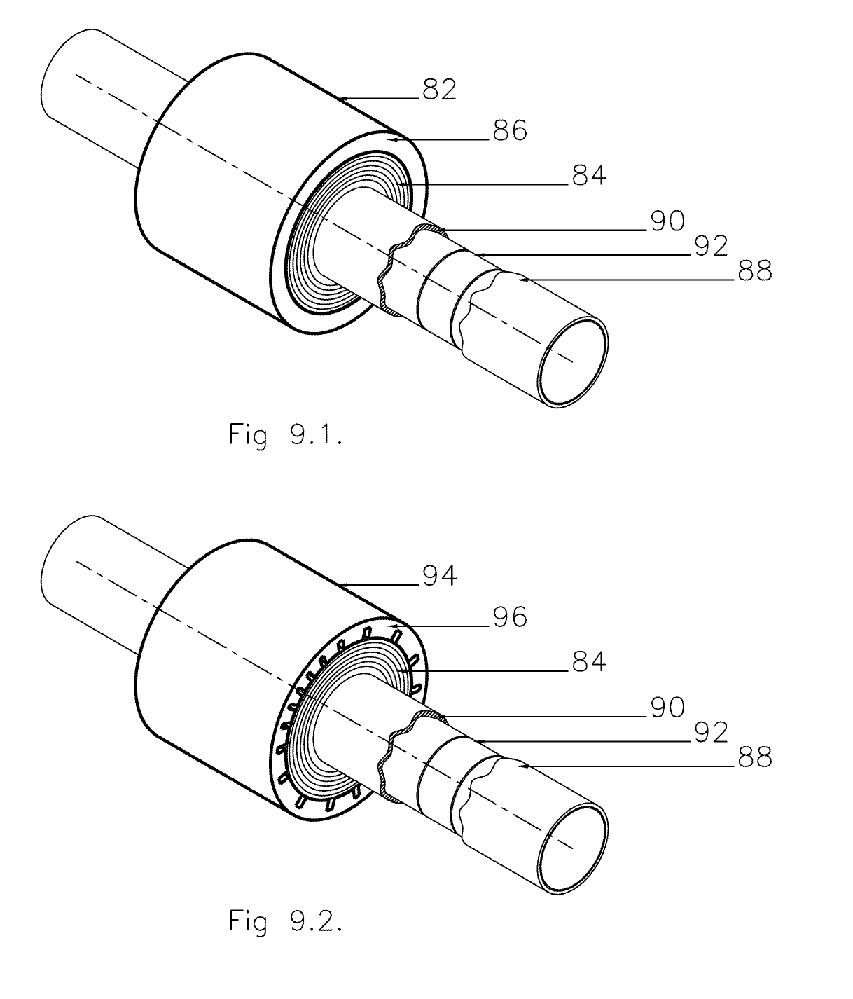

Linear tube (internal magnets) slotless motor with forcer that includes coils and solid or laminated core for coils mounting is shown on FIG. 9.1. Forcer 82 consists of coils 84 and solid or laminated core 86. Magnet track 88 consists of magnetic tube 90 and magnets 92.

The invented linear tube (internal magnets) slotless motor construction includes forcer 94 consisted of coils 84 and grooved core 96 (FIG. 9.2). The grooved core replaces conventional solid or laminated core 86. It is much easier in production than laminated core and do not have significant Eddy currents losses due to grooves.

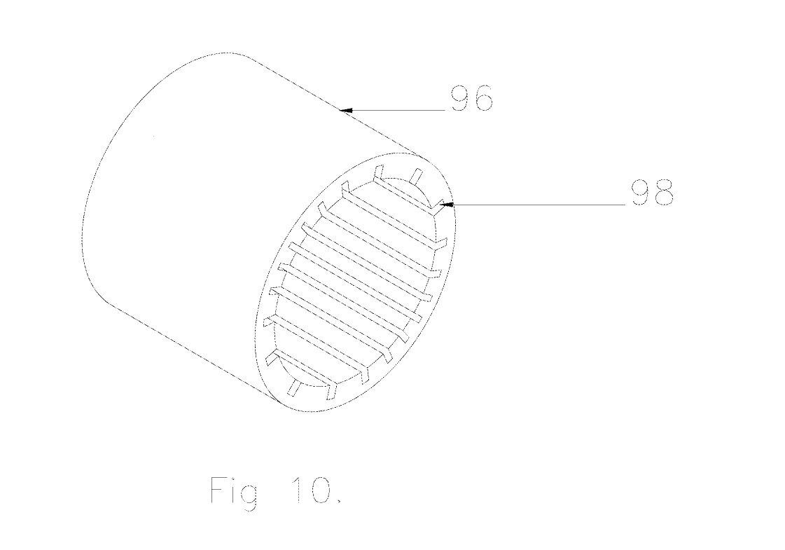

The grooved core 96 for linear tube (internal magnets) slotless motor is shown on FIG. 10. It is made of solid oriented or non-oriented, ferromagnetic or non-ferromagnetic material or compound. Grooves 98 are made along the core length (parallel to motor moving direction), or other direction. The exact dimensions, direction and quantity of grooves depend on electromechanical design and are subject for optimization.

Linear Tube (External Magnets) Slotless Motor with Grooved Core.

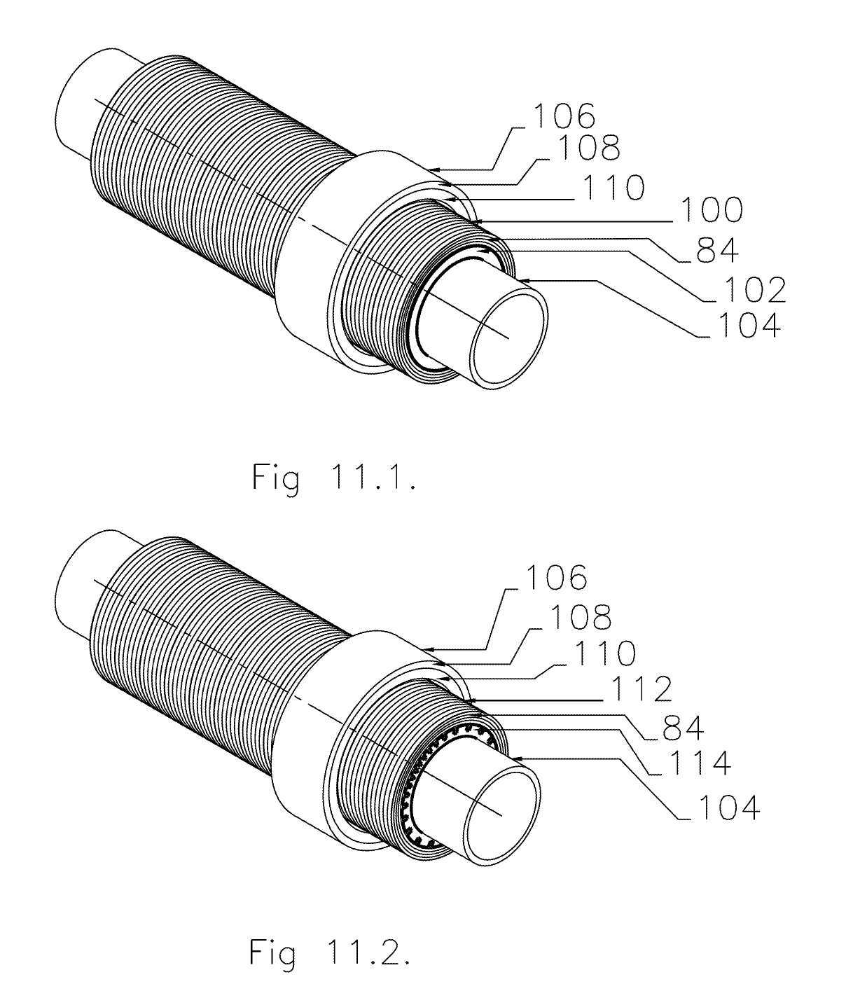

Linear tube (external magnets) slotless motor with forcer that includes coils and solid or laminated core for coils mounting is shown on FIG. 11.1. Forcer 100 consists of coils 84, solid or laminated core 102 and bushing 104. Magnet track 106 consists of magnetic tube 108 and magnets 110.

The invented linear tube (external magnets) slotless motor construction includes forcer 112 consisted of coils 84, grooved core 114 and bushing 104 (FIG. 11.2). The grooved core replaces conventional solid or laminated core 102. It is much easier in production than laminated core and do not have significant Eddy currents losses due to grooves.

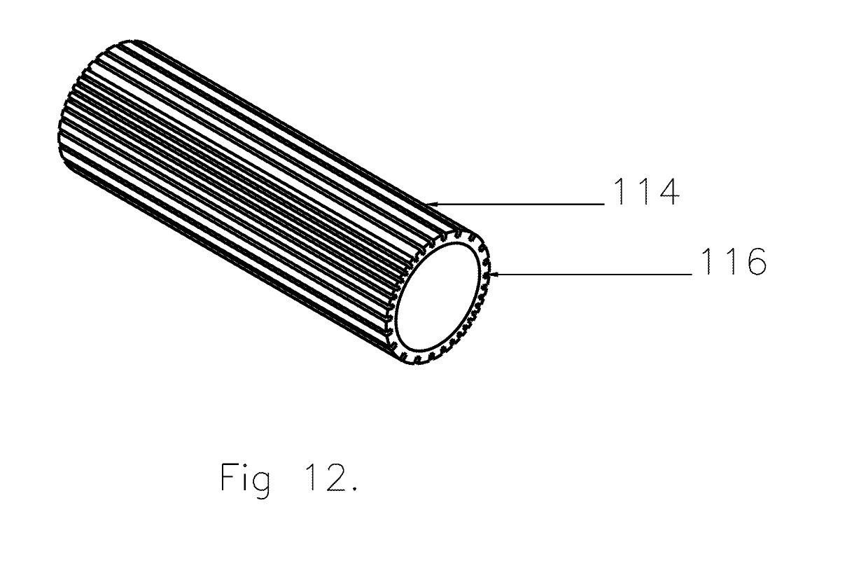

The grooved core 114 for linear tube (external magnets) slotless motor is shown on FIG. 12. It is made of solid oriented or non-oriented, ferromagnetic or non-ferromagnetic material or compound. Grooves 116 are made along the core length (parallel to motor moving direction), or other direction. The exact dimensions, direction and quantity of grooves depend on electromechanical design and are subject for optimization.

1. A slotless motor, comprising:
a) grooved core having a solid oriented or non-oriented, ferromagnetic or non-ferromagnetic material or compound,
b) grooves are made along the core length (parallel to motor moving direction), perpendicular the rotation axis (parallel to motor rotation), corkscrew direction, spiral direction or other direction.

2. A rotary radial slotless (internal or external rotor) or axial slotless motor, comprising:
a) grooved core having a solid oriented or non-oriented, ferromagnetic or non-ferromagnetic material or compound,
b) grooves are made perpendicular the rotation axis (parallel to motor rotation), corkscrew direction, spiral direction or other direction.

3. A linear flat slotless or tubular (internal magnets or external magnets) slotless motor, comprising:
a) grooved core having a solid oriented or non-oriented, ferromagnetic or non-ferromagnetic material or compound,
b) grooves are made along the core length (parallel to motor moving direction) or other direction.
